(19) United States
(12) Patent Application Publication
(10) Pub. No.: US 2024/0289589 A1
(43) Pub. Date: Aug. 29, 2024

(54) EXTERNAL MEMORY ARCHITECTURE FOR RECURRENT NEURAL NETWORKS

(71) Applicant: University of Florida Research Foundation, Incorporated, Gainesville, FL (US)

(72) Inventors: Jose C. Principe, Gainesville, FL (US); Ran Dou, Gainesville, FL (US)

(21) Appl. No.: 18/501,277

(22) Filed: Nov. 3, 2023

Related U.S. Application Data
(60) Provisional application No. 63/423,141, filed on Nov. 7, 2022.

(51) Int. Cl. G06N 3/0442

(52) U.S. Cl. CPC G06N 3/0442

(57) ABSTRACT

A universal recurrent event memory network system comprising a query block configured to generate one or more query vectors, a key block configured to generate one or more key vectors, a value block configured to generate one or more value vectors, and an external memory comprising a key vector block and a value vector block. The external memory is configured to compare similarity between the one or more query vectors and the one or more key vectors and generate one or more read vectors based at least in part on the comparison and the one or more value vectors. The universal recurrent event memory network system further comprising an output block configured to generate one or more outputs based at least in part on the one or more read vectors and a previous memory state.

### CROSS REFERENCE TO RELATED APPLICATION

This application claims the priority of U.S. Provisional Application No. 63/423,141, entitled “EXTERNAL MEMORY ARCHITECTURE FOR RECURRENT NEURAL NETWORKS,” filed on Nov. 7, 2022, the disclosure of which is hereby incorporated by reference in its entirety.

### GOVERNMENT SUPPORT

This invention was made with government support under W911NF-21-1-0254 awarded by the US ARMY RESEARCH OFFICE. The government has certain rights in the invention.

### TECHNICAL FIELD

The present disclosure relates to artificial neural network systems, and more particularly to an event memory architecture for recurrent neural networks.

### BACKGROUND

Time series analysis has been widely studied for years and continues to be an active research area. State models have been the norm for extracting information from time series. As such, it is essential for models, such as autoregressive moving average (ARMA), hidden Markov model (HMM), and recurrent neural networks (RNNs) to be able to preserve and propagate hidden information. Existing artificial memory models, such as moving average (MA) are the simplest and easiest to train, while autoregressive (AR) models use recurrency and are more efficient. A linear memory model is another existing artificial memory which compromises between memory depth and resolution. RNNs may employ nonlinear memories that are substantially complex in computation and includes problems, such as vanishing gradients. HMMs may assume a set of unobservable states in a dynamic system to model transitions.

However, all of the aforementioned artificial memory models suffer from an inability to represent long term dependencies. Taking symbolic time series as an example, a prediction is affected by a current input sample, previous hidden state, and knowledge of history (e.g., of past input samples).

Gated recurrent neural networks can be used to create a representation linking the current to past samples with arbitrary lags by controlling switches for an external hidden state, which may greatly improve the processing of long-term dependencies for time series models. However, gated recurrent neural networks propagate hidden information by merging states at different times into one representative state. When the external representation is updated, past information is forgotten. One solution to this problem is to store the external information separately in multiple memory locations. However, adapting external memory architectures require constructing read and write operations using continuous functions, which create resolution and redundancy issues that are hard to optimize.

Thus, there is a need for a memory architecture that may be used with machine learning that overcomes the deficiencies of existing artificial memory models.

### BRIEF SUMMARY

Various embodiments described herein relate to a universal recurrent event memory network architecture for recurrent neural networks that is compatible with different types of time series data such as scalar, multivariate or symbolic. The disclosed universal recurrent event memory network architecture may comprise an external memory that stores key-value pairs, which separates information for addressing and content. The key-value pairs may also provide linear adaptive mapping functions, while implementing nonlinear mapping from inputs to outputs.

According to one embodiment, a universal recurrent event memory network system is provided. In some embodiments, the universal recurrent event memory network system comprises a query block configured to generate one or more query vectors based at least in part on a read operation; a key block configured to generate one or more key vectors based at least in part on an input sample data; a value block configured to generate one or more value vectors based at least in part on the input sample data; an external memory coupled to one or more neural networks associated with a machine learning model, the external memory comprising a key vector block and a value vector block, wherein (i) the key vector block is configured to receive the one or more key vectors from the key block, (ii) the value vector block is configured to receive the one or more value vectors from the value block, and (iii) the external memory is coupled to one or more processors configured to execute one or more classification tasks, using the machine learning model, by: (a) comparing similarity between the one or more query vectors and the one or more key vectors, and (b) generating one or more read vectors based at least in part on the comparison and the one or more value vectors; and an output block configured to generate one or more outputs of the machine learning model based at least in part on the one or more read vectors and a previous memory state.

In some embodiments, the output block is further configured to generate the one or more outputs by concatenating the read vector and the previous memory state. In some embodiments, the read vector comprises a weighted linear combination of a product of the one or more value vectors and a similarity measure value between the one or more query vectors and the one or more key vectors. In some embodiments, the query block, the key block, and the value block are configured to receive for each time instance, an input sample and the previous memory state. In some embodiments, the query block is configured to generate the one or more query vectors based at least in part on the input sample and the previous memory state. In some embodiments, the key block is configured to generate the one or more key vectors based at least in part on the input sample and the previous memory state. In some embodiments, the value block is configured to generate the one or more value vectors based at least in part on the input sample and the previous memory state.

In some embodiments, the one or more key vectors comprise information associated with future addressing. In some embodiments, the one or more value vectors comprise information associated with content. In some embodiments, the external memory is further configured to store the one or more key vectors and the one or more value vectors as one or more key-value pairs associated with one or more time instances. In some embodiments, the external memory is further configured to select the one or more key-value pairs based on the similarity between the one or more query vectors and the one or more key vectors. In some embodiments, the one or more key-value pairs are representative of one or more events associated with the one or more time instances. In some embodiments, the one or more events comprise one or more words of a statement. In some embodiments, the external memory is configured to represent the statement by relating the one or more events with a recurrent hidden state.

In some embodiments, the external memory is configured to encode the one or more words with the input sample data and a previous hidden state. In some embodiments, (i) the one or more key vectors comprise one or more keys, (ii) the one or more value vectors comprise one or more values, and (iii) the one or more keys are nonlinearly mapped to the one or more values. In some embodiments, the one or more classification tasks comprise a time series prediction, a logic operator task, or question answering comprising natural language processing. In some embodiments, the external memory is configured to execute the time series prediction by comparing similarities between the one or more query vectors and the key vectors at one or more time instances associated with how information from past samples are preserved and/or discarded. In some embodiments, the external memory is configured to execute the one or more classification tasks by capturing one or more input features associated with the input sample data with one or more keys associated with the one or more key vectors; and storing one or more values associated with the one or more outputs in the one or more value vectors. In some embodiments, the external memory is configured to operate with continuous values and operators comprising smooth functions.

### BRIEF DESCRIPTION OF THE DRAWINGS

Embodiments incorporating teachings of the present disclosure are shown and described with respect to the figures presented herein.

FIG. 1 illustrates key-value pairs and nonlinear mapping in accordance with some embodiments discussed herein.

FIG. 2 illustrates a schematic diagram of an example universal recurrent event memory network architecture that can be used to practice embodiments of the present disclosure.

FIG. 3 illustrates an exemplary overview of an architecture that can be used to practice embodiments of the present disclosure.

FIG. 4 illustrates an example predictive data analysis computing entity in accordance with some embodiments discussed herein.

FIG. 5 illustrates an example client computing entity in accordance with some embodiments discussed herein.

FIG. 6 illustrates depicts a graphical comparison of experimental results in accordance with some embodiments discussed herein.

FIG. 7 illustrates key and value matrices in an external memory in accordance with some embodiments discussed herein.

FIG. 8 illustrates a visualization of memory access through testing of an external memory in accordance with some embodiments discussed herein.

FIG. 9 illustrates a comparison of prediction performance in accordance with some embodiments discussed herein.

FIG. 10 illustrates a performance chart with memory filling in accordance with some embodiments discussed herein.

FIG. 11 and FIG. 12 illustrate visualizations for copy and reverse character tasks in accordance with some embodiments discussed herein.

FIG. 13 illustrates plots of copy tasks of randomly generated sequences for testing generalization in accordance with some embodiments discussed herein.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### General Overview and Exemplary Technical Improvements

The capabilities of neural networks may be extended by coupling neural networks to external memory. An external memory M may take the form of,

$$M = [ \begin{matrix}M ( 1 ) \\ M ( 2 ) \\ … \\ M ( n )\end{matrix} ] ∈ {R}^{n \times m} \qquad ( 1 )$$

where M(i) may represent the ith item stored in memory M with a size of m bits, and n may represent the memory size, which limits the number of items that can be stored in the memory M.

An external memory may be accessed by read and write operations. The read operation may copy memory contents and the write operation may either add new items to memory or erase existing items from memory. Controllers that emit commands to an external memory may be referred to as read and write heads. Unlike conventional read and write operations in digital computers, external memory in machine learning may operate with continuous values and operators comprising smooth functions.

In a read operation, the read head may emit a set of weights wᵢ^{r} for each location, and for normalization, the sum of these weights equals to 1.

$${{\sum }^{n}}_{i = 1} {w}_{i}^{r} = 1 \qquad ( 2 )$$

A read vector rₜ may defined by a weighted combination of memory items Mₜ(i) at location i.

$${r}_{t} = {{\sum }^{n}}_{i = 1} {w}_{i}^{r} {M}_{t} ( i ) \qquad ( 3 )$$

However, it is noted that the value of the memory Mₜ(i) is multiplied by a vector of constant norm, which is a convolution operation. Hence, small variations in Mₜ(i) can be lost in a read operation, affecting the precision of the operator.

A write operation may comprise an erase operation. At time t, a write head may emit erase weights wₜ^{e}. The erased memory may be updated by,

$${\tilde{M}}_{t} ( i ) = {M}_{t} ( i ) ( 1 - {w}_{t}^{e} ( i ) ) \qquad ( 4 )$$

where \acute{M}ₜ(i) represents the memory after erasing. Upon erasing, the write head may emit a value vector vₜ to be stored into the memory and a weight vector wₜ for the locations.

$${M}_{t + 1} ( i ) = {\tilde{M}}_{t} ( i ) + {w}_{t}^{w} ( i ) {v}_{t} \qquad ( 5 )$$

Performing the read and write operations may require an addressing mechanism. In particular, two types of addressing mechanisms may be used concurrently for neural memories-content-based addressing and location-based addressing.

For content-based addressing, a query vector q may be emitted by the heads at time t. Then, the weight wₜ^{c}(i) may be defined by a similarity between qₜ and Mₜ(i). Using K( ) to denote the similarity measure,

$${w}_{t}^{c} ( i ) = K ( {M}_{t} ( i ) , {q}_{t} ) \qquad ( 6 )$$

For location-based addressing, a scalar interpolation gate gₜϵ(0, 1) may be emitted by the heads. Then, the weight may be updated by,

$${w}_{t} = {g}_{t} {w}_{t}^{c} + ( 1 - {g}_{t} ) {w}_{t - 1} \qquad ( 7 )$$

External memory may be based at least in part on mimicking computer memory operations for neural network applications. However, there exist shortcomings for such an implementation. Conceptually, external memory in a computer may comprise a set of physical addresses where pointers (memory addresses) are used to retrieve values from the physical addresses. In neural networks, to make this operation differentiable, a memory item is used for both addressing and content which is dissimilar from computer memories. This limits the precision of the memory as well as its capacity.

Furthermore, state memory architectures suffer from a trade-off between memory depth and resolution. For a recurrent system, information may decay at a certain rate μϵ(0, 1) when propagating through time. For example, a small decay rate means that information decays slowly and has been smoothed in time, which causes a poor time resolution because local samples are averaged together. A memory depth d represents a furthest sample that a memory system can gain information from. A product of resolution and memory depth for linear memories may comprise a constant given by a filter order. A tradeoff also exists for nonlinear state machine learning models, such as conventional recurrent neural network (RNN), but the product of memory and resolution is much harder to determine analytically. For external memory, the memory depth can be improved, but at the sacrifice of resolution. That is, when a read head emits a query vector qₜ, it may only retrieve items that are similar to it. A memory system gains little from a read content rₜ and the query vector qₜ containing similar information. Therefore, external memories still suffer from a trade-off between resolution and memory depth.

To solve the aforementioned shortcomings, the present disclosure discloses a universal recurrent event memory network architecture that separates memory event information into key and value vectors. In particular, various embodiments of the present disclosure comprise a universal recurrent event memory network architecture for using external memory with recurrent neural networks based at least in part on key-value pairs and nonlinear mapping. Query, key, and value as described in the present disclosure refer to functionalities that are similar to digital computer memories' implementation of address (key) and memory content (value). As such, external memory for recurrent networks may be accessed in a similar manner. By doing so, long-term information can be retrieved by querying key and value matrices.

According to various embodiments of the present disclosure, event information for a given time or instance are separated into two vectors, one for the addressing (e.g., key) and another for content (e.g., value), both of which are stored into an external memory. In some embodiments, the disclosed universal recurrent event memory network architecture comprises an addressing system submodule and a read content submodule. The addressing system submodule may be configured to manage physical addresses. The read content submodule may be configured to operate as content storage, e.g., similar to non-volatile memory. The addressing system submodule and the read content submodule may operate in tandem to retrieve information from the external memory.

In one embodiment, the external memory is controlled by a single layer linear recurrent machine learning model and can achieve state-of-the-art performance with a much smaller number of trainable parameters when compared with machine learning models using nonlinearities on different tasks such as chaotic time series prediction, logic operator tasks and question answering dataset (bAbI) in natural language processing. Key-value decomposition of memory events may be used by the disclosed external memory to obviate memory depth resolution trade-off and avoid precision efficiency bottleneck created by the implementation of continuous read and write operators. In some embodiments, a universal recurrent event memory network architecture may comprise linear adaptive mapping functions associated with key-value pairs to simplify construction of nonlinearity, which may be necessary in most memory applications. In some embodiments, the disclosed universal recurrent event memory network architecture may allow for an external memory to be decoded by one linear layer, e.g., instead of using a Softmax output, as commonly used in convention natural language processing machine learning models.

### Exemplary Technical Implementation of Various Embodiments

Embodiments of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FcRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of a data structure, apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described with reference to example operations, steps, processes, blocks, and/or the like. Thus, it should be understood that each operation, step, process, block, and/or the like may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically configured machines performing the steps or operations specified in the block diagrams and flowchart illustrations. Accordingly, the block diagrams and flowchart illustrations support various combinations of embodiments for performing the specified instructions, operations, or steps.

### Exemplary Universal Recurrent Event Memory Network Architecture

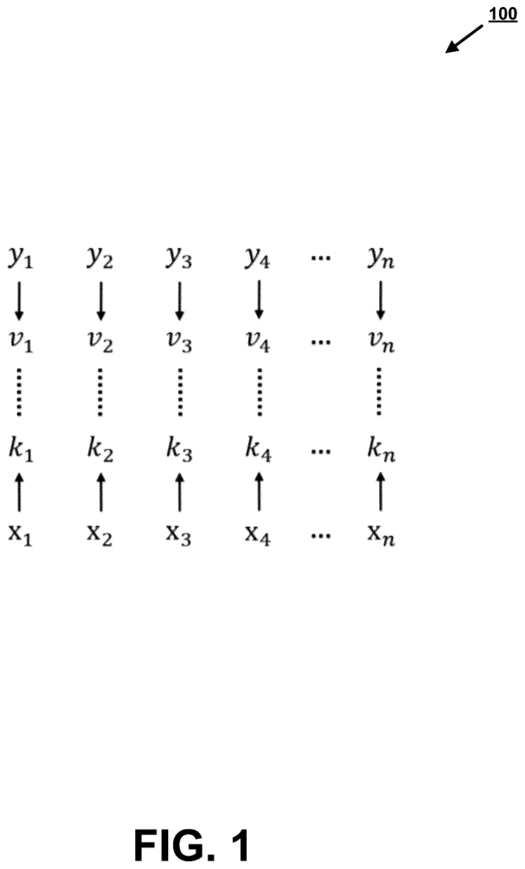

FIG. 1 depicts key-value pairs and nonlinear mapping of an example universal recurrent event memory network architecture. Given a set of input features {x₁, x₂, . . . , xₙ} and corresponding desired outputs {y₁, y₂, . . . , yₙ}, the goal of a feedforward neural network is to find the weights θ for the nonlinear mapping function f_{θ}( ) that provides a minimum prediction error.

$${θ}_{opt} = {min}_{θ} E ( loss ( {f}_{θ} ( {x}_{i} ) , {y}_{i} ) ) \qquad ( 8 )$$

According to various embodiments of the present disclosure, the disclosed universal recurrent event memory network architecture may separate addresses from contents, and as such a content submodule may be nonlinear. Moreover, because of time resolution, local nonlinearity may be used, such as Gaussian kernel, to simplify nonlinear mapping.

As shown in FIG. 1, for a classification task, a key vector comprising keys {k₁, k₂ . . . , kₙ} may be used to capture input features and a value vector comprising values {v₁, v₂, . . . , vₙ} may be used to store corresponding values from the desired output. When a new input sample is received, similarity based at least in part on a Gaussian kernel G may be used to select key-value pairs based at least in part on the keys and provide an output associated the values. For example, given a set of features {1, 2, 3, 4} for an input and {1, −1, 1, −1} for corresponding labels, at least one hidden layer with nonlinear activation function may be needed for classification. To achieve this, key-value pairs {(k, v): (1, 1), (2,−1), (3, 1), (4,−1)} may be created and the nonlinear mapping can be expressed as,

$$f ( x ) = {G}_{σ} ( x , 1 ) - {G}_{σ} ( x , 2 ) + {G}_{σ} ( x , 3 ) - {G}_{σ} ( x , 4 ) \qquad ( 9 )$$

where σ can be set as a small value to make the Gaussian close to an impulse. Compared to black-box hidden layer operations, the disclosed key-value pair architecture implements a mapping in a much simpler and concise manner that is easy to understand. Also, since similarity is evaluated based at least in part on data points, the disclosed key-value pair architecture tends to be zero for out of distribution data. In this way, nonlinear mapping from inputs to outputs can be easily built by a key-value pair architecture.

The following natural language processing example for illustrating embodiments of the present disclosure is provided: “Mary went to the kitchen.” In this statement, each word is related to the others, and each word may be stored separately as an event. Memory for this sentence may be triggered by any word. For example, “Mary” may be recalled from memory that she went to the kitchen. The word “went” may be identified from the memory that the subject is Mary instead of someone else. Similarly, “kitchen” may be identified from the memory that Mary is there and how she got there.

Therefore, according to one embodiment of the disclosed universal recurrent event memory network architecture, a recurrent hidden state may connect words, such as in the example statement, with each other. In an encoding phase, each word may be encoded by a current input as well as a previous hidden state. The hidden state may be updated with the previous state information. A read content operation from memory may be performed to provide long term information.

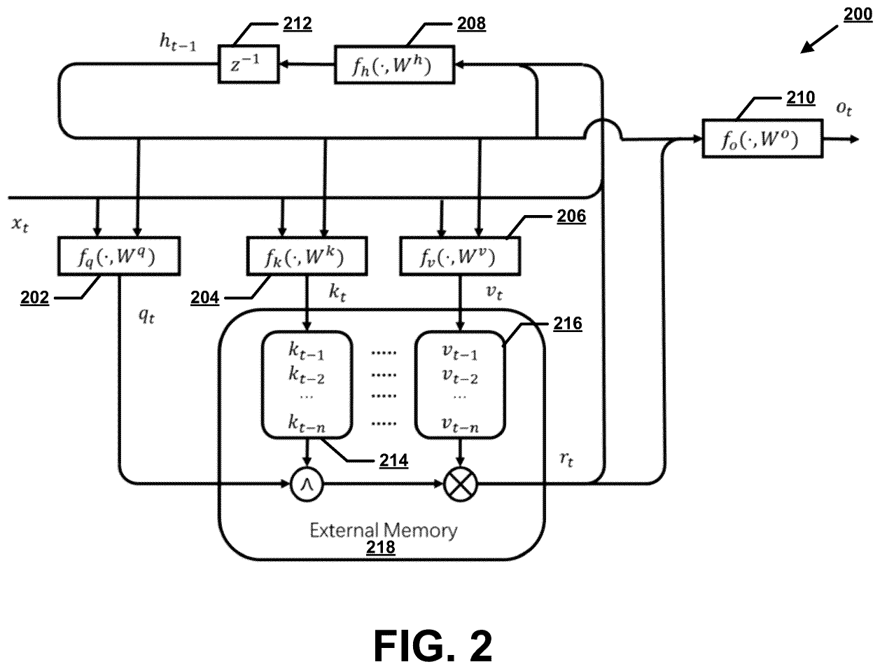

FIG. 2 is a schematic diagram of an example universal recurrent event memory network architecture 200. The universal recurrent event memory network architecture 200 comprises a query block 202, a key block 204, a value block 206, a state block 208, an output block 210, a delay block 212, a key vector block 214, and a value vector block 216.

As shown in FIG. 2, at time t, given a new input sample xₜ and previous memory state hₜ₋₁, three vectors may be generated: a query vector qₜ by query block 202, a key vector kₜ by key block 204, and a value vector vₜ by value block 206. The key vector kₜ may contain information for future addressing and the value vector vₜ may contain information for content. For example, for the question “Where did Mary go?” the information in the word “Mary” and “go” may be used for addressing and the word “kitchen” may be used for the answer. Both key and value vectors may form an event at time t. At each time t, an event (key-value pair (kₜ, vₜ)) may be pushed into an external memory.

The external memory 218 may comprise a universal recurrent event memory network architecture and a set of key-value pairs (via key vector block 214 and value vector block 216),

$$\{ ( {k}_{t - 1} , {v}_{t - 1} ) , ( {k}_{t - 2} , {v}_{t - 2} ) , … , ( {k}_{t - n} , {v}_{t - n} ) \vert {k}_{i} ∈ {R}^{{n}_{k}} , {v}_{i} ∈ {R}^{{n}_{v}} \} \qquad ( 10 )$$

where nₖ may represent the size of the key vector kᵢ, and nᵥ may represent the size of the value vector vᵢ, and n may represent the size of the external memory 218. In some embodiments, keys in key vector block 214 are nonlinearly mapped to values in value vector block 216.

The query vector qₜ for a read operation may be used for addressing the previous event location in the external memory 218 and may be generated by,

$${q}_{t} = {f}_{q} ( {x}_{t} , {h}_{t - 1} , {W}^{q} ) \qquad ( 11 )$$

where W_{q} may represent the weights for f_{q}( ). Then, by comparing similarity between the query vector qₜ and key vector kᵢ in the external memory 218, a read vector rₜ may be generated comprising a weighted linear combination of a product of value vectors vₜ and a similarity measure value between the query vector qₜ and key vector kᵢ.

$${r}_{t} = {{\sum }^{n}}_{i = 1} {v}_{t - i} K ( {q}_{t} , {k}_{t - i} ) \qquad ( 12 )$$

In the above equation, K( ) may represent a similarity measure implemented by Gaussian. The Gaussian may create an induced metric that contains the information of all the event moments of the probability density of the input data.

For each event in the external memory 218, the key vector kₜ and value vector vₜ may be generated based at least in part on the same input but different parameters.

$${k}_{t} = {f}_{k} ( {x}_{t} , {h}_{t - 1} , {W}^{k} ) \qquad ( 13 )$$

$${v}_{t} = {f}_{v} ( {x}_{t} , {h}_{t - 1} , {W}^{v} ) \qquad ( 14 )$$

where W^{k} and W^{v} may represent the weights for fₖ( ) and fᵥ( ).

Then, the key-value pair (kₜ, vₜ) may be pushed into the external memory 218. When the external memory 218 is full, it may follow a first-in-first-out (FIFO) rule to discard and add events. The hidden state may be updated at state block 208 by,

$${h}_{t} = {f}_{h} ( {r}_{t} , {x}_{t} , {h}_{t - 1} , {W}^{h} ) \qquad ( 15 )$$

where Wₕ is the weights for fₕ( ).

The output of may be determined at output block 210 by concatenating the read vector rₜ and the previous memory state hₜ₋₁ as,

$${o}_{t} = {f}_{o} ( {r}_{t} , {h}_{t - 1} , {W}^{o} ) \qquad ( 16 )$$

where Wₒ may represent the weights for fₒ( ). The previous memory state hₜ₋₁ may be generated by providing output of state block 208 and input to delay block 212.

The blocks depicted in FIG. 2 may comprise linear operators. To simplify, the sizes for the functional vectors (qₜ, kₜ, vₜ, hₜ) may be the same and referred as nₕ. The following presents update equations:

$${q}_{t} = {W}_{x}^{q} {x}_{t} + {W}_{h}^{q} {h}_{t - 1} \qquad ( 17 )$$

$${k}_{t} = {W}_{x}^{k} {x}_{t} + {W}_{h}^{k} {h}_{t - 1} \qquad ( 18 )$$

$${v}_{t} = {W}_{x}^{v} {x}_{t} + {W}_{h}^{v} {h}_{t - 1} \qquad ( 19 )$$

The size for input sample xₜ may be nₓ. Weights Wₓ^{q}, Wₓ^{k} and Wₓ^{v} may comprise matrices with size nₕ×nₓ, and weights Wₕ^{q}, Wₕ^{k} and Wₕ^{v} may comprise matrices with size nₕ×nₕ. To implement the external memory 218 in coding, two memory buffers, KeyₜϵR^{n×n}^{ₕ} may be generated for the key, and ValueₜϵR^{n×n}^{ₕ} may be generated for the value, while following FIFO. For example, at each time, a new key-value pair is pushed into the external memory 218 and a key-value pair at the bottom is discarded. When the external memory 218 is empty, the key and value matrices may be initialized with zeros.

Using Gaussian similarity, the read content rₜ can be expressed as,

$${r}_{t} = {{\sum }^{n}}_{i = 1} {v}_{t - i} {G}_{σ} ( {k}_{t - i} , {q}_{t} ) \qquad ( 20 )$$

where σ may represent the kernel size. The update for hidden state and output oₜ may be,

$${h}_{t} = {W}_{r}^{h} {r}_{t} + {W}_{x}^{h} {x}_{t} + {W}_{h}^{h} {h}_{t - 1} \qquad ( 21 )$$

$${o}_{t} = {W}_{r}^{o} {r}_{t} + {W}_{h}^{o} {h}_{t - 1} \qquad ( 22 )$$

The size for oₜ may be nₒ. The sizes for Wᵣ^{h} and Wₕ^{h} may be nₕ×nₕ. The sizes for Wₓ^{h} may be nₕ×nₓ and for Wᵣ^{o} and Wₕ^{o} are nₒ×nₕ.

The above equations may be representative of a RNN comprising an external memory without explicit nonlinear activation function. The error at time t may be expressed as,

$${e}_{t} = {d}_{t} - {o}_{t} \qquad ( 23 )$$

Taking the mean squared error (MSE) as the cost function, at time t+1,

$${J}_{t + 1} ( W ) = \frac{1}{2} {e}_{t + 1}^{T} {e}_{t + 1} \qquad ( 24 )$$

where W={Wₓ^{q}; Wₕ^{q}; Wₓ^{k}; Wₕ^{k}; Wₓ^{v}; Wₕ^{v}; Wₓ^{h}; Wₕ^{h}; Wᵣ^{h}; Wᵣ^{o}; Wₕ^{o}}.

When taking the gradient,

$$\frac{{dJ}_{t + 1}}{dW} = - {e}_{t + 1}^{T} \frac{{do}_{t + 1}}{dW} \qquad ( 25 )$$

For the output layer,

$$\frac{{dJ}_{t + 1}}{{dW}_{r}^{o}} = - {e}_{t + 1}^{T} {r}_{t + 1} \qquad ( 26 )$$

$$\frac{{dJ}_{t + 1}}{{dW}_{h}^{o}} = - {e}_{t + 1}^{T} {h}_{t} \qquad ( 27 )$$

For the other blocks, chain rule may be applied,

$$\frac{{dJ}_{t + 1}}{{do}_{t + 1}} \frac{{do}_{t + 1}}{dW} = \frac{{dJ}_{t + 1}}{{do}_{t + 1}} ( \frac{{do}_{t + 1}}{{dr}_{t + 1}} \frac{{dr}_{t + 1}}{dW} + \frac{{do}_{t + 1}}{{dh}_{t}} \frac{{dh}_{t}}{dW} ) \qquad ( 28 )$$

$$\frac{{do}_{t + 1}}{{dr}_{t + 1}} = {W}_{r}^{o} \qquad ( 29 )$$

$$\frac{{do}_{t + 1}}{{dh}_{t}} = {W}_{h}^{o} \qquad ( 30 )$$

The gradient along the path of the hidden state he may be computed though time,

$$\frac{{dh}_{t}}{dW} = {W}_{r}^{h} \frac{{dr}_{t}}{dW} + {W}_{h}^{h} \frac{{dh}_{t - 1}}{dW} \qquad ( 31 )$$

The gradient to rₜ is propagated to the qₜ, kₜ, and vₜ vectors.

$$\frac{{dr}_{t}}{{dq}_{t}} = - \frac{1}{σ} {{\sum }^{n}}_{i = 1} {v}_{t - i} ( {q}_{t} - {k}_{t - i} ) {e}^{- \frac{{‖ {q}_{t} - {k}_{t - i} ‖}^{2}}{2 σ}} \qquad ( 32 )$$

$$\frac{{dr}_{t}}{{dk}_{t - i}} = \frac{1}{σ} {v}_{t - i} ( {q}_{t} - {k}_{t - i} ) {e}^{- \frac{{‖ {q}_{t} - {k}_{t - i} ‖}^{2}}{2 σ}} \qquad ( 33 )$$

$$\frac{{dr}_{t}}{{dv}_{t - i}} = {e}^{- \frac{{‖ {q}_{t} - {k}_{t - i} ‖}^{2}}{2 σ}} \qquad ( 34 )$$

Given the gradients above, the query, key, and value vectors may be optimized and tend to learn different types of information for different usages. For instance, weights for the query vector are more likely to learn long term dependency compared with the key and value vectors because the gradient of the query vector comprises a summation of the list of event memories. Then, for the read content at time t,

$$\frac{{dr}_{t}}{dW} = \frac{{dr}_{t}}{{dq}_{t}} \frac{{dq}_{t}}{dW} + {{\sum }^{n}}_{i = 1} ( \frac{{dr}_{t}}{{dk}_{t - i}} \frac{{dk}_{t - i}}{dW} + \frac{{dr}_{t}}{{dv}_{t - i}} \frac{{dv}_{t - i}}{dW} ) \qquad ( 35 )$$

For the read block,

$$\frac{{dq}_{t}}{{dW}_{x}^{q}} = {x}_{t} \qquad ( 36 )$$

$$\frac{{dq}_{t}}{{dW}_{h}^{q}} = {h}_{t - 1} \qquad ( 37 )$$

For weights other than Wₓ^{q} and Wₕ^{q},

$$\frac{{dq}_{t}}{{dW}^{′}} = {W}_{h}^{q} \frac{{dh}_{t - 1}}{{dW}^{′}} \qquad ( 38 )$$

The gradients are the same for key block and value block,

$$\frac{{dk}_{t}}{{dW}_{x}^{k}} = {x}_{t} \qquad ( 39 )$$

$$\frac{{dk}_{t}}{{dW}_{h}^{k}} = {h}_{t - 1} \qquad ( 40 )$$

$$\frac{{dv}_{t}}{{dW}_{x}^{v}} = {x}_{t} \qquad ( 41 )$$

$$\frac{{dv}_{t}}{{dW}_{h}^{v}} = {h}_{t - 1} \qquad ( 42 )$$

For the weights from other blocks,

$$\frac{{dk}_{t}}{{dW}^{′}} = {W}_{h}^{k} \frac{{dh}_{t - 1}}{{dW}^{′}} \qquad ( 43 )$$

$$\frac{{dv}_{t}}{{dW}^{′}} = {W}_{h}^{v} \frac{{dh}_{t - 1}}{{dW}^{′}} \qquad ( 44 )$$

### Exemplary Computing System Architecture

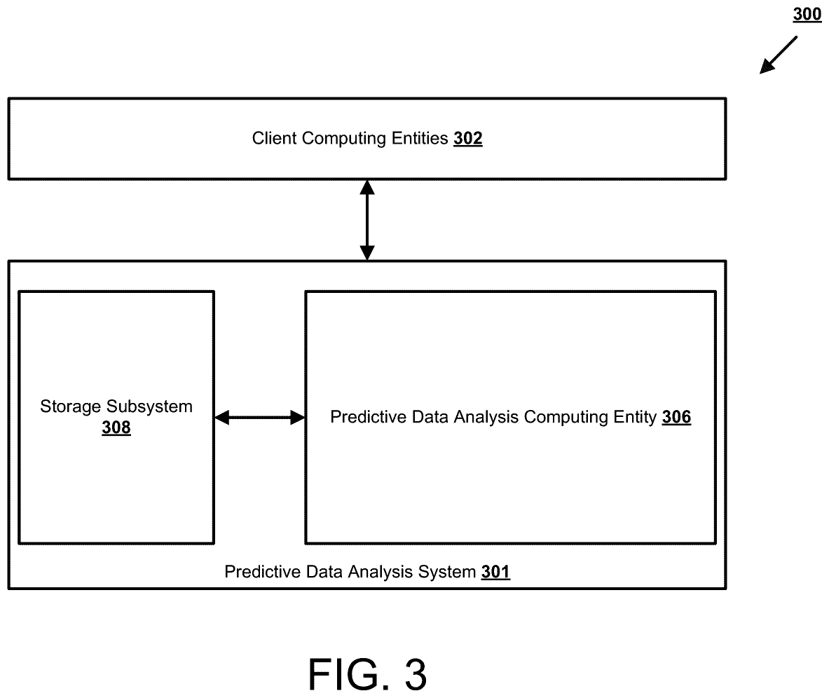

FIG. 3 is a schematic diagram of an example architecture 300 for performing predictive data analysis. The architecture 300 includes a predictive data analysis system 301 configured to receive predictive data analysis requests from client computing entities 302, process the predictive data analysis requests to generate predictions, provide the generated predictions to the client computing entities 302, and automatically perform prediction-based actions based at least in part on the generated predictions.

An example of a prediction-based action that can be performed using the predictive data analysis system 301 is a response to a query request. For example, in accordance with various embodiments of the present disclosure, a predictive machine learning model may be trained to predict responses to queries based at least in part on training data comprising data points, features, or facts for creating event memories. Data associated training of the machine learning may be stored by the predictive machine learning model to an external memory according to the presently disclosed universal recurrent event memory network architecture. As such, the predictive machine learning model may require a smaller number of trainable parameters when compared with machine learning models using nonlinearities. This technique will lead to higher accuracy of performing predictive operations. In doing so, the techniques described herein improve efficiency and speed of training predictive machine learning models, thus reducing the number of computational operations needed and/or the amount of training data entries needed to train predictive machine learning models. Accordingly, the techniques described herein improve at least one of the computational efficiency, storage-wise efficiency, and speed of training predictive machine learning models.

In some embodiments, predictive data analysis system 301 may communicate with at least one of the client computing entities 302 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, and/or the like).

The predictive data analysis system 301 may include a predictive data analysis computing entity 306 and a storage subsystem 308. The predictive data analysis computing entity 306 may be configured to receive predictive data analysis requests from one or more client computing entities 302, process the predictive data analysis requests to generate predictions corresponding to the predictive data analysis requests, provide the generated predictions to the client computing entities 302, and automatically perform prediction-based actions based at least in part on the generated predictions.

The storage subsystem 308 may be configured to store input data (e.g., external memory) used by the predictive data analysis computing entity 306 to perform predictive data analysis as well as model definition data used by the predictive data analysis computing entity 306 to perform various predictive data analysis tasks. The storage subsystem 308 may include one or more storage units, such as multiple distributed storage units that are connected through a computer network. Each storage unit in the storage subsystem 308 may store at least one of one or more data assets and/or one or more data about the computed properties of one or more data assets. Moreover, each storage unit in the storage subsystem 308 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### Exemplary Predictive Data Analysis Computing Entity

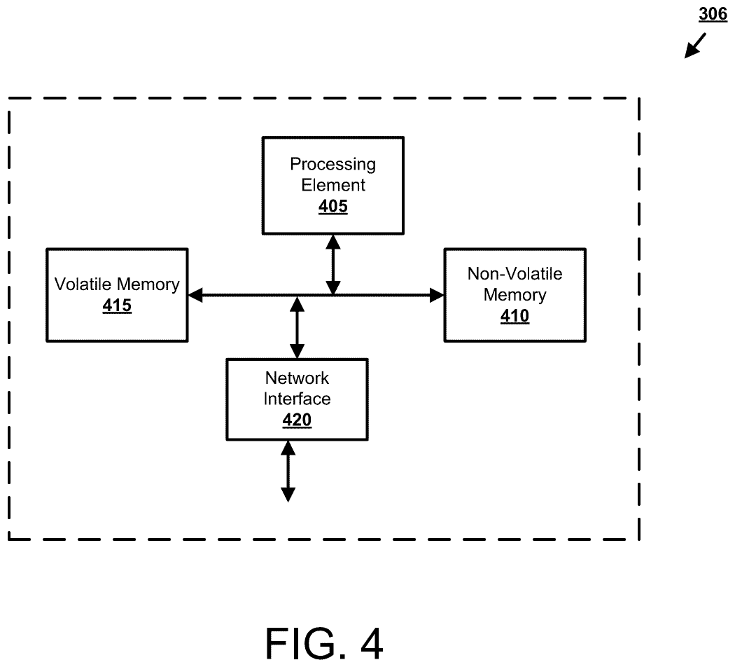

FIG. 4 provides a schematic of a predictive data analysis computing entity 306 according to one embodiment of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the predictive data analysis computing entity 306 may also include one or more network interfaces 420 for communicating with various computing entities, such as by communicating data, content, information, and/or similar terms used herein interchangeably that can be transmitted, received, operated on, processed, displayed, stored, and/or the like.

As shown in FIG. 4, in one embodiment, the predictive data analysis computing entity 306 may include, or be in communication with, one or more processing elements 405 (also referred to as processors, processing circuitry, and/or similar terms used herein interchangeably) that communicate with other elements within the predictive data analysis computing entity 306 via a bus, for example. As will be understood, the processing element 405 may be embodied in a number of different ways.

For example, the processing element 405 may be embodied as one or more complex programmable logic devices (CPLDs), microprocessors, multi-core processors, coprocessing entities, application-specific instruction-set processors (ASIPs), microcontrollers, and/or controllers. Further, the processing element 405 may be embodied as one or more other processing devices or circuitry. The term circuitry may refer to an entirely hardware embodiment or a combination of hardware and computer program products. Thus, the processing element 405 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 405 may be configured for a particular use or configured to execute instructions stored in volatile or non-volatile media or otherwise accessible to the processing element 405. As such, whether configured by hardware or computer program products, or by a combination thereof, the processing element 405 may be capable of performing steps or operations according to embodiments of the present disclosure when configured accordingly.

In one embodiment, the predictive data analysis computing entity 306 may further include, or be in communication with, non-volatile media (also referred to as non-volatile storage, memory, memory storage, memory circuitry and/or similar terms used herein interchangeably). In one embodiment, the non-volatile storage or memory may include one or more non-volatile memory 410, including, but not limited to, hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the predictive data analysis computing entity 306 may further include, or be in communication with, volatile media (also referred to as volatile storage, memory, memory storage, memory circuitry and/or similar terms used herein interchangeably). In one embodiment, the volatile storage or memory may also include one or more volatile memory 415, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 405. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 306 with the assistance of the processing element 405 and operating system.

As indicated, in one embodiment, the predictive data analysis computing entity 306 may also include one or more network interfaces 420 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 306 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 306 may include, or be in communication with, one or more input elements, such as a keyboard input, a mouse input, a touch screen/display input, motion input, movement input, audio input, pointing device input, joystick input, keypad input, and/or the like. The predictive data analysis computing entity 306 may also include, or be in communication with, one or more output elements (not shown), such as audio output, video output, screen/display output, motion output, movement output, and/or the like.

### Exemplary Client Computing Entity

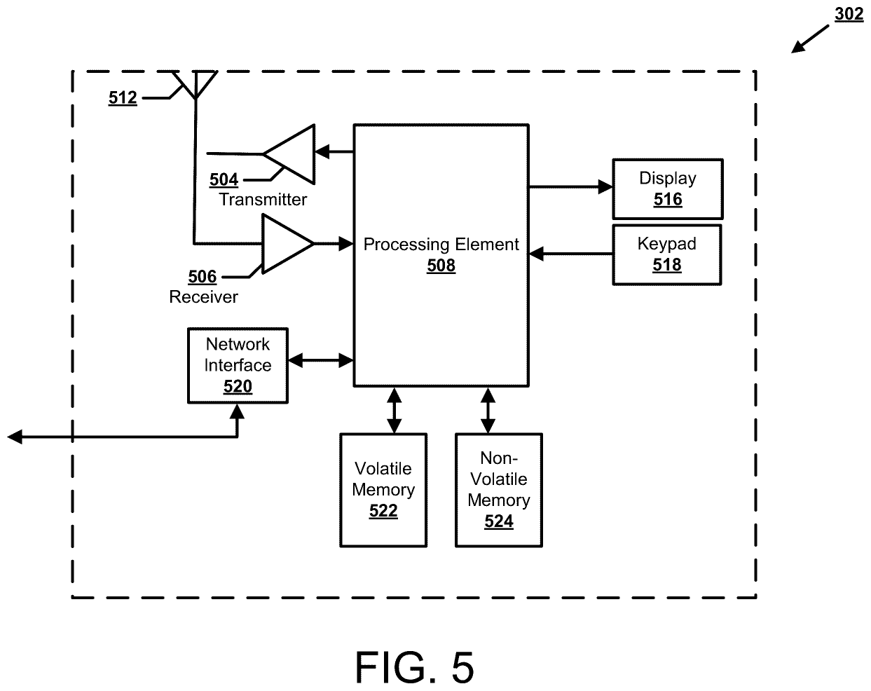

FIG. 5 provides an illustrative schematic representative of a client computing entity 302 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 302 can be operated by various parties. As shown in FIG. 5, the client computing entity 302 can include an antenna 512, a transmitter 504 (e.g., radio), a receiver 506 (e.g., radio), and a processing element 508 (e.g., CPLDs, microprocessors, multi-core processors, coprocessing entities, ASIPs, microcontrollers, and/or controllers) that provides signals to and receives signals from the transmitter 504 and receiver 506, correspondingly.

The signals provided to and received from the transmitter 504 and the receiver 506, correspondingly, may include signaling information/data in accordance with air interface standards of applicable wireless systems. In this regard, the client computing entity 302 may be capable of operating with one or more air interface standards, communication protocols, modulation types, and access types. More particularly, the client computing entity 302 may operate in accordance with any of a number of wireless communication standards and protocols, such as those described above with regard to the predictive data analysis computing entity 306. In a particular embodiment, the client computing entity 302 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 302 may operate in accordance with multiple wired communication standards and protocols, such as those described above with regard to the predictive data analysis computing entity 306 via a network interface 520.

Via these communication standards and protocols, the client computing entity 302 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 302 can also download changes, add-ons, and updates, for instance, to its firmware, software (e.g., including executable instructions, applications, program modules), and operating system.

According to one embodiment, the client computing entity 302 may include location determining aspects, devices, modules, functionalities, and/or similar words used herein interchangeably. For example, the client computing entity 302 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data can be collected using a variety of coordinate systems, such as the DecimalDegrees (DD); Degrees, Minutes, Seconds (DMS); Universal Transverse Mercator (UTM); Universal Polar Stereographic (UPS) coordinate systems; and/or the like. Alternatively, the location information/data can be determined by triangulating the client computing entity's 302 position in connection with a variety of other systems, including cellular towers, Wi-Fi access points, and/or the like. Similarly, the client computing entity 302 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The client computing entity 302 may also comprise a user interface (that can include a display 516 coupled to a processing element 508) and/or a user input interface (coupled to a processing element 508). For example, the user interface may be a user application, browser, user interface, and/or similar words used herein interchangeably executing on and/or accessible via the client computing entity 302 to interact with and/or cause display of information/data from the predictive data analysis computing entity 306, as described herein. The user input interface can comprise any of a number of devices or interfaces allowing the client computing entity 302 to receive data, such as a keypad 518 (hard or soft), a touch display, voice/speech or motion interfaces, or other input device. In embodiments including a keypad 518, the keypad 518 can include (or cause display of) the conventional numeric (0-9) and related keys (#, *), and other keys used for operating the client computing entity 302 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The client computing entity 302 can also include volatile memory 522 and/or non-volatile memory 524, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the client computing entity 302. As indicated, this may include a user application that is resident on the entity or accessible through a browser or other user interface for communicating with the predictive data analysis computing entity 306 and/or various other computing entities.

In another embodiment, the client computing entity 302 may include one or more components or functionality that are the same or similar to those of the predictive data analysis computing entity 306, as described in greater detail above. As will be recognized, these architectures and descriptions are provided for exemplary purposes only and are not limiting to the various embodiments.

In various embodiments, the client computing entity 302 may be embodied as an artificial intelligence (AI) computing entity, such as an Amazon Echo, Amazon Echo Dot, Amazon Show, Google Home, and/or the like. Accordingly, the client computing entity 302 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### Example Experimental Implementation and Results of Various Embodiments

According to one experiment, a Chaotic Time Series prediction was performed using the disclosed universal recurrent event memory network architecture. Similarities between query and keys were compared at each time to determine how information from past samples are preserved and/or discarded. In particular, the disclosed universal recurrent event memory network architecture was tested on a Hénon map, which may comprise a discrete-time dynamical system that exhibits chaotic behavior. For example, at each time, the system takes the previous coordinate (xₜ₋₁, yₜ₋₁) and maps it to a new coordinate,

$$\{ \begin{matrix}{x}_{t} = 1 - 1.4 {x}_{t - 1}^{2} + {y}_{t - 1} \\ {y}_{t} = 0.3 {x}_{t - 1}\end{matrix} \qquad ( 45 )$$

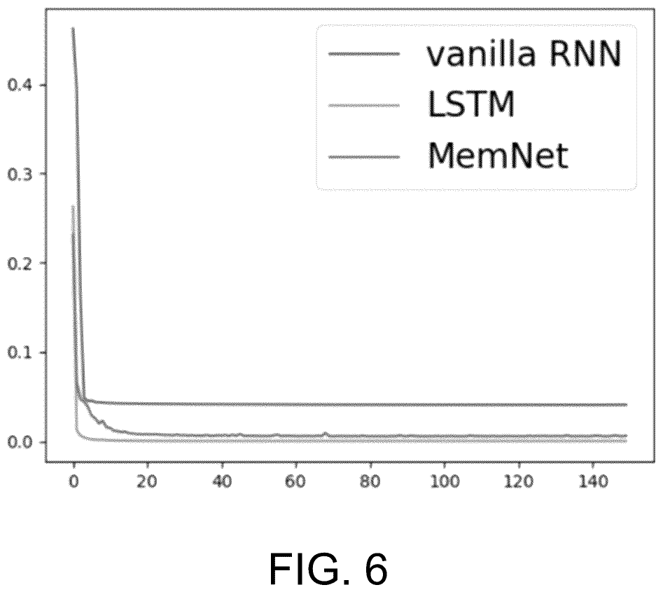

FIG. 6 depicts a graphical comparison of learning curves of a conventional RNN machine learning, a long short-term memory (LSTM) machine learning, and a machine learning model comprising an external memory (herein referred to as an external memory machine learning model) according to one embodiment of the disclosed universal recurrent event memory network architecture. The hidden layer sizes for the three machine learning models were selected according to one that exhibits the best performance. For example, the machine learning models may include a hidden embedding size of 8 and an external memory size of 64. The hidden embedding may correspond to the number of “bits” in the memory, although here each value is a real number. The three machine learning models may use the same optimizer, e.g., Adam with a learning rate of 0.01. As depicted in FIG. 6, the best performer was the LSTM because of its longer memory. The external memory machine learning model is very close to the performance of the LSTM but much simpler to train. As such, the disclosed universal recurrent event memory network architecture is very effective for time series prediction, despite only adapting linear mappers.

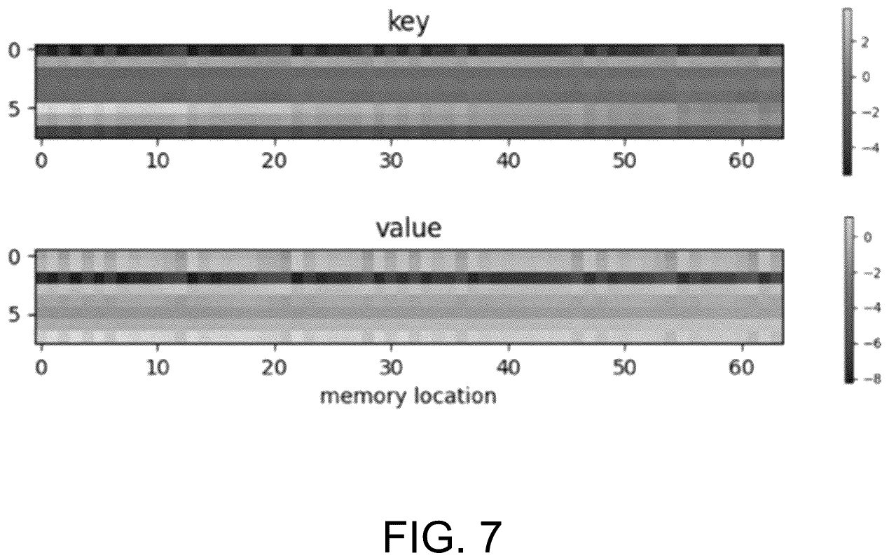

FIG. 7 depicts key and value matrices in an external memory according to one embodiment of the disclosed universal recurrent event memory network architecture at the end of a training sequence. As depicted in FIG. 7, more recent events are at the top of the buffer, near zero at the left of the X-axis. The Y-axis may represent 8 embedding dimensions corresponding to the hidden embedding size, as discussed in the example. Values of the memory keys may evolve smoothly across training to provide the required memory depth for addressing. However, the bits for the value sub module can quickly change from sample to sample across the training to provide accurate information resolution for each memory location.

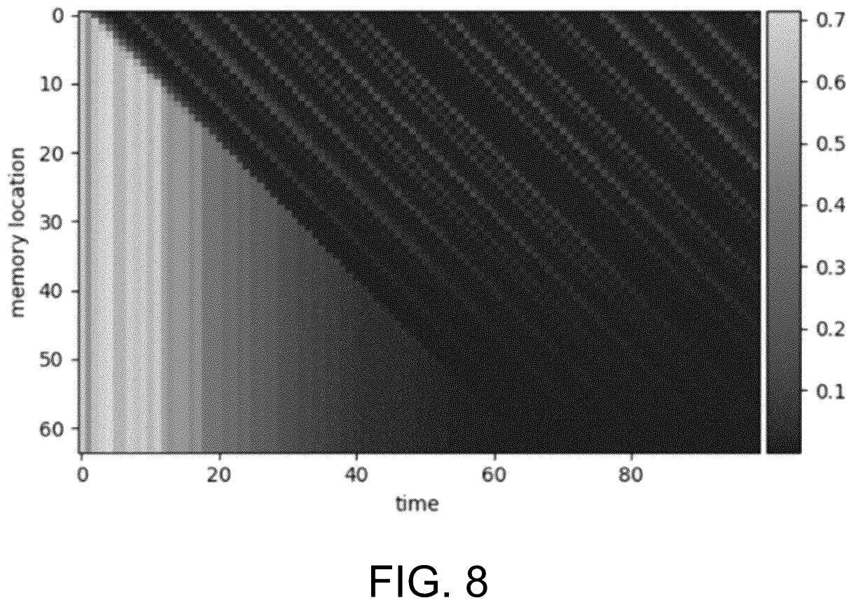

FIG. 8 depicts a visualization of memory access (e.g., similarity measure between the query vector and the keys) through testing of the external memory according to one embodiment of the disclosed universal recurrent event memory network architecture. The external memory size of 64 may correspond to 64 locations in the external memory and the similarity measure can be a vector with size 64 at each time. A high value may represent the corresponding weight for the value is high, and a strong connection between the past sample and the current input may be made. New memory values may be pushed one by one to the external memory where the value 0 on the Y-axis may represent the latest memory item. The external memory may be initialized with zeros for the key and value matrices, and the similarities may be constant for these locations when the external memory is not full (vertical bars in the left part of the memory buffer). Due to the lack of information from hidden states and the read content, initial queries may be close to zero, causing high similarities with zero keys. A query vector may be differentiated from zero upon building the external memory and decreased similarities with zero keys. Similarity may be more discriminant in a quasi-linear region of a Gaussian where Gaussian has the largest slope. Keys and queries may tend to fall into such region as depicted in FIG. 8 by color code. In regression applications, similarity may not be close to 1. FIG. 8 also depicts that once the external memory is full, the information may be retrieved quasi-periodically through time, mimicking the time structure of the Hénon time series. Depicted diagonal lines may be associated with the external memory in the buffer being shifted one right e.g., the same information appears in the next column.

According to another experiment, to validate an assumption that an external memory machine learning model according to one embodiment of the disclosed universal recurrent event memory network architecture is free from scale of data, its performance was tested on an air passenger dataset comprising a number of monthly air passengers in thousands from 1949 until 1960. The difficulty for predicting this dataset is that the mean and variance tends to increase along time, creating a heteroscedastic time series. Thus, an external memory machine learning model according to one embodiment of the disclosed universal recurrent event memory network architecture would learn mean trend as well as periodic seasonal fluctuation.

For this particular experiment, the dataset included a total of 144 data points, where 96 points were used as the training set, 24 points were used as the validation set, and 48 points were used in the test set. The model order was selected by one that has smallest error on the validation data. The embedding size was configured to 12 and the external memory size was configured to 16. Adam optimizer was also chosen with a learning rate of 0.01. Upon training the external memory machine learning model, two types of tasks were conducted on the test set. The first task was to test the long-term prediction performance. In the first task, the training data was fed into the model to create event memories. Then, the model used previous prediction as next input. The model was then configured to predict the 48 test points using the information contained in the external memory.

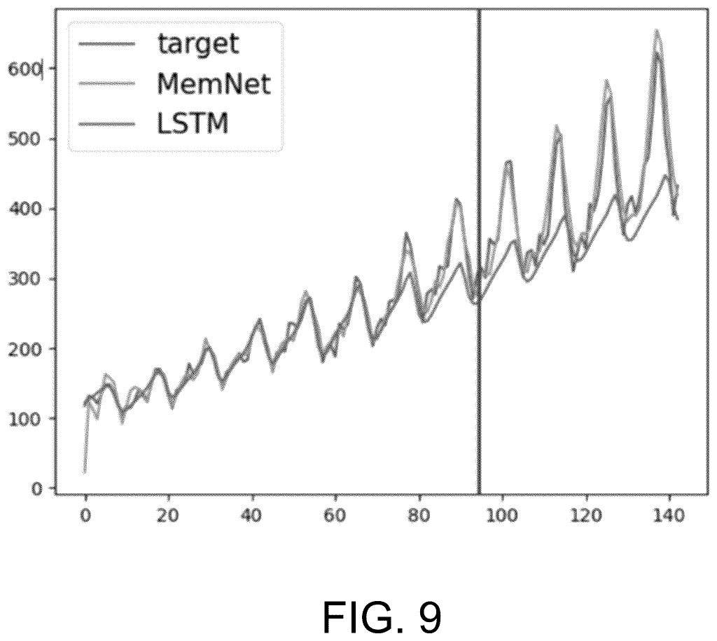

FIG. 9 depicts a comparison of prediction performance by an external memory machine learning model according to one embodiment of the disclosed universal recurrent event memory network architecture. Testing of a LSTM model on the same dataset was performed as a comparison. Because of the heteroscedastic in the time series, a conventional LSTM saturates the external memory and cannot be used. As such, the mean was removed from the training set data as a pre-processing step and allowed the LSTM to learn just the variance. For testing, the mean was added back to the prediction. As shown in FIG. 9, the external memory machine learning model according to one embodiment of the disclosed universal recurrent event memory network architecture learns both the trend and fluctuation very well while the LSTM is incapable of predicting recursively the time series.

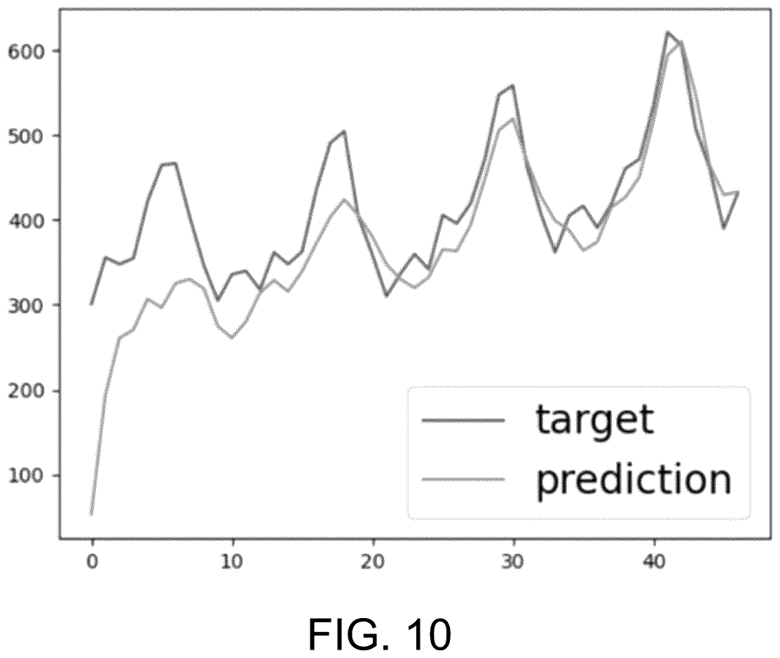

The external memory machine learning model according to one embodiment of the disclosed universal recurrent event memory network architecture was also tested, with all parameters fixed from the training set, whether it could capture the phase and synchronize with the test data when the external memory was cleared. This was test was performed by receiving the test data, filling the external memory incrementally, and predicting a next value, as depicted by FIG. 10. As depicted in FIG. 10, a model using external memory displays poor performance on prediction during filling up of the memory, but after 16 samples, it starts to predict the time series progressively well.

According to another experiment, symbolic operation tasks were performed to test an external memory machine learning model according to one embodiment of the disclosed universal recurrent event memory network architecture, where input sequences are randomly generated and without any temporal information. To visualize how the model works on symbolic operation tasks in bit strings, such as copy and reverse character, its performance was compared with a Neural Turing Machine. The input data comprised a sequence of bits generated randomly where the target goal was to return the same symbols in the same order or its reverse order. For each symbolic operation task, the model was trained on sequences with lengths from 1 to 20. The embedding size was configured to 32, the event memory size was configured to 128, and an Adam optimizer was used with a learning rate of 0.0001.

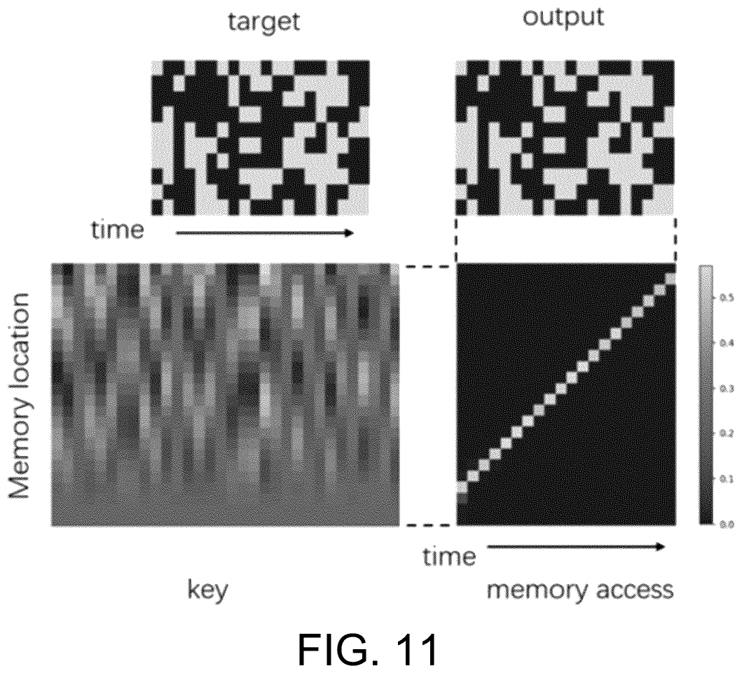

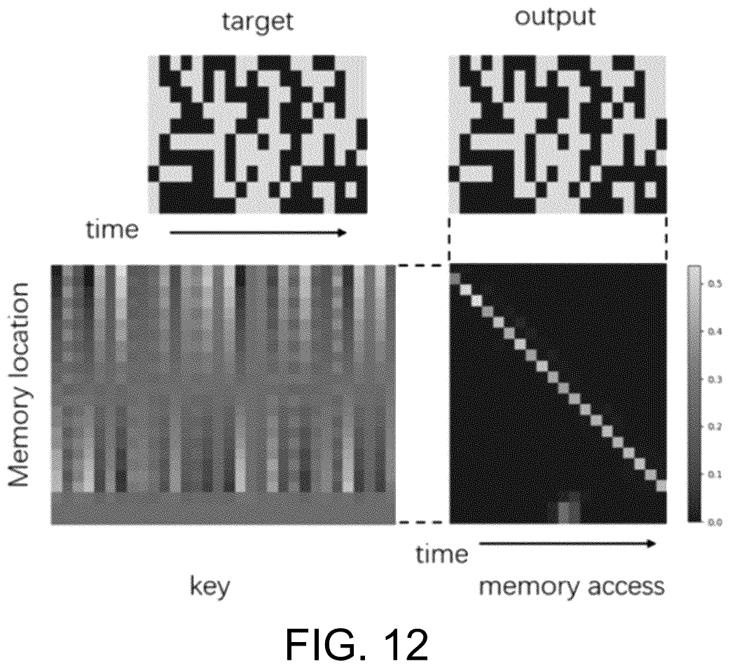

Visualizations for the copy and reverse character tasks are depicted in FIGS. 11 and 12, respectively. FIGS. 11 and 12 depict that the model performs the tasks with no errors for strings up to 20. It is noted that the learned memory keys in the external memory for the same input were quite different in the two tasks. This may be expected because the targets are quite different, thus, the operations may also be different. Furthermore, memory access between the two tasks were mirror images, which can be expected since the order of the samples is flipped between the tasks.

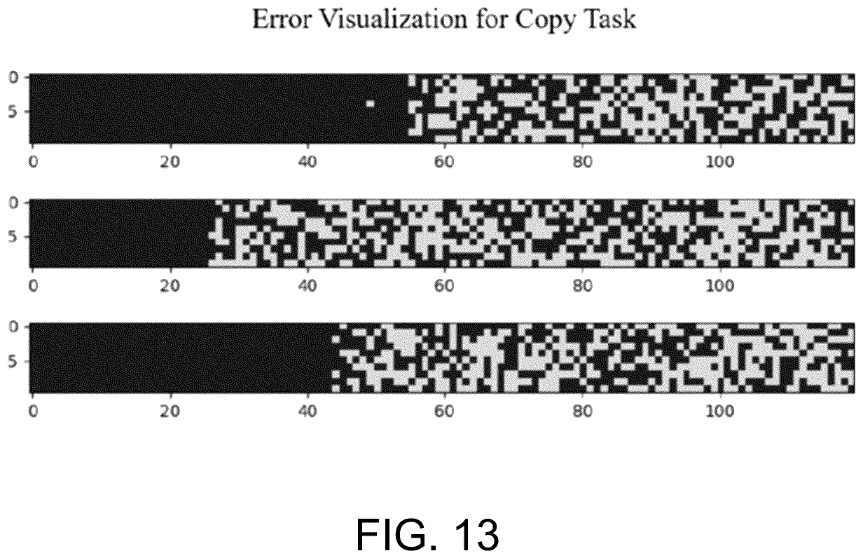

Generalization of the external memory machine learning model according to one embodiment of the disclosed universal recurrent event memory network architecture was also tested with copy tasks for longer sequences. FIG. 13 depicts three plots of copy tasks of randomly generated sequences with a length of 120. As depicted in FIG. 13, the model can generalize for longer sequences but starts failing after length 25 for some of the sequences, while for others it can generalize for lengths up to 50.

An external memory machine learning model according to one embodiment of the disclosed universal recurrent event memory network architecture, was also tested using the question answering dataset bAbI to show its capability on language understanding and information retrieval. The bAbI dataset contains 20 different types of questions, which are designed for text understanding and reasoning. Each task contains a list of stories. For each story, there are several clue sentences mixed with some irrelevant sentences, and each story has several questions. For example,
1 Mary got the football there.
2 John went to the kitchen.
3 Mary went back to the kitchen.
4 Mary went back to the garden.
5 Where is the football? garden 1 4
6 Daniel went back to the kitchen.
7 Mary dropped the football.
8 John got the milk there.
9 Where is the football? garden 7 4

The first number in each sentence represents an index. The number after the question represents the reference for the question. For example, when answering the question for sentence 5, “Where is the football?” the useful information is contained in sentence 1 and sentence 4. Each story may be a separate sequence and every word and punctuation may comprise a vector using one-hot encoding. No other word embedding techniques were used. For each sequence, the order of the statements and questions were followed.

The external memory of the model was reset at the beginning of each sequence. When the model encountered a question, the model stopped memorizing and took the question as input. The last output of the model was treated as the answer. After answering a question, the model was allowed to continue memorizing new statements for future questions. For the experiment, two types of training were conducted on the dataset, single and joint queries. For single training, 20 models were trained separately on the 20 tasks. The memory size for the model was configured to 512 and the embedding size was uniformly set to 32. A single linear layer was used for the blocks in FIG. 2. Adam was used as the optimizer with a learning rate of 0.0001 and no weight decay. Zero padding was not used for the online learning. For the joint training, there were 194 words and punctuations in total and the size for one-hot embedding was 194. The same configurations as used for single training was used except for using 64 as the embedding size.

Table 1 depicts exemplary results comparison of the external memory machine learning model according to one embodiment of the disclosed universal recurrent event memory network architecture (referred to as “MemNet”). The model achieved a mean error rate of 2.96% and 1 failed task for single training; and a mean error rate of 5.6% with 3 failures for joint training. The model provided high performance in most of the single tasks, but performance degrades in the joint tasks. Results were worse than the state-of-the-art transformer network, but architecture and training is much simpler. When compared with other models, such as Neural Turing Machines (NTM) and Differentiable Neural Computers (DNC) that also use state models with external memory, the model's mean error was much better than NTM and slightly worse than the DNC, which are both much more complex architectures. The model compared favorably with the attention networks MemN2N and Dynamic Memory Networks (DMN), which are also quite large networks.

TABLE 1

| | bAbI Best Results | | | | | | | |
|---|---|---|---|---|---|---|---|---|
| | NTM | DNC | MemN2N | MemN2N | DMN | MEMO* | MemNet | MemNet |
| Task | (Joint) | (Joint) | (Joint) | (Single) | (Single) | (Joint) | (Single) | (Joint) |
| 1: 1 supporting fact | 31.5 | 0 | 0 | 0 | 0 | 0 | 0 | 0 |
| 2: 2 supporting facts | 54.5 | 1.3 | 1 | 0.3 | 1.8 | 0 | 1.6 | 0.17 |
| 3: 3 supporting facts | 43.9 | 2.4 | 6.8 | 2.1 | 4.8 | 2.95 | 2.6 | 0.7 |
| 4: 2 argument rels | 0 | 0 | 0 | 0 | 0 | 0 | 0 | 0 |
| 5: 3 argument rels | 0.8 | 0.5 | 6.1 | 0.8 | 0.7 | 0 | 1.3 | 0.8 |
| 6: yes/no questions | 17.1 | 0 | 0.1 | 0.1 | 0 | 0 | 0 | 0 |
| 7: counting | 17.8 | 0.2 | 6.6 | 2 | 3.1 | 0 | 0 | 3.2 |
| 8: lists/sets | 13.8 | 0.1 | 2.7 | 0.9 | 3.5 | 0 | 0 | 7.2 |
| 9: simple negation | 16.4 | 0 | 0 | 0.3 | 0 | 0 | 0 | 0 |
| 10: indefinite knowl. | 16.6 | 0.2 | 0.5 | 0 | 0 | 0 | 0.1 | 0.6 |
| 11: basic coreference | 15.2 | 0 | 0 | 0.1 | 0.1 | 0 | 0 | 0 |
| 12: conjunction | 8.9 | 0.1 | 0.1 | 0 | 0 | 0 | 0 | 0 |
| 13: compound coref. | 7.4 | 0 | 0 | 0 | 0.2 | 0 | 0 | 0 |
| 14: time reasoning | 24.2 | 0.3 | 0 | 0.1 | 0 | 0 | 0 | 4.2 |
| 15: basic deduction | 47 | 0 | 0.2 | 0 | 0 | 0 | 0 | 0 |
| 16: basic induction | 53.6 | 52.4 | 0.2 | 51.8 | 0.6 | 1.25 | 48.5 | 0.6 |
| 17: positional reas. | 25.5 | 24.1 | 41.8 | 18.6 | 40.4 | 0 | 0 | 6.3 |
| 18: size reasoning | 2.2 | 4 | 8 | 5.3 | 4.7 | 0 | 0.1 | 0 |
| 19: path finding | 4.3 | 0.1 | 75.7 | 2.3 | 65.5 | 0 | 4.7 | 87.3 |
| 20: agent motiv. | 1.5 | 0 | 0 | 0 | 0 | 0 | 0 | 0 |
| Mean Err. (%) | 20.1 | 4.3 | 7.5 | 4.2 | 6.4 | 0.21 | 2.96 | 5.6 |
| Failed (err. >5%) | 16 | 2 | 6 | 3 | 2 | 0 | 1 | 3 |

As depicted in Table 2, the tested model (referred to as “MemNet”) with hidden size of 64 has a much smaller number of trainable parameters than the others on the jointly training task.

TABLE 2

| | LSTM | NTM | DNC | MemNet |
|---|---|---|---|---|
| Hidden Size | 512 | 256 | 256 | 64 |
| Learning Rate | 10⁻⁴ | 10⁻⁴ | 10⁻⁴ | 10⁻⁴ |
| Read Heads | ~ | 16 | 16 | 1 |
| Model Size | >1452k | >846k | >1050k | 95k |

### CONCLUSION

It should be understood that the examples and embodiments described herein are for illustrative purposes only and that various modifications or changes in light thereof will be suggested to persons skilled in the art and are to be included within the spirit and purview of this application.

Many modifications and other embodiments of the present disclosure set forth herein will come to mind to one skilled in the art to which the present disclosures pertain having the benefit of the teachings presented in the foregoing descriptions and the associated drawings. Therefore, it is to be understood that the present disclosure is not to be limited to the specific embodiments disclosed and that modifications and other embodiments are intended to be included within the scope of the appended claim concepts. Although specific terms are employed herein, they are used in a generic and descriptive sense only and not for purposes of limitation.

1. A universal recurrent event memory network system comprising:
a query block configured to generate one or more query vectors based at least in part on a read operation;
a key block configured to generate one or more key vectors based at least in part on an input sample data;
a value block configured to generate one or more value vectors based at least in part on the input sample data;
an external memory coupled to one or more neural networks associated with a machine learning model, the external memory comprising a key vector block and a value vector block, wherein (i) the key vector block is configured to receive the one or more key vectors from the key block, (ii) the value vector block is configured to receive the one or more value vectors from the value block, and (iii) the external memory is coupled to one or more processors configured to execute one or more classification tasks, using the machine learning model, by:
(a) comparing similarity between the one or more query vectors and the one or more key vectors, and
(b) generating one or more read vectors based at least in part on the comparison and the one or more value vectors; and
an output block configured to generate one or more outputs of the machine learning model based at least in part on the one or more read vectors and a previous memory state.

2. The universal recurrent event memory network system of claim 1, wherein the output block is further configured to generate the one or more outputs by concatenating the read vector and the previous memory state.

3. The universal recurrent event memory network system of claim 1, wherein the read vector comprises a weighted linear combination of a product of the one or more value vectors and a similarity measure value between the one or more query vectors and the one or more key vectors.

4. The universal recurrent event memory network system of claim 1, wherein the query block, the key block, and the value block are configured to receive for each time instance, an input sample and the previous memory state.

5. The universal recurrent event memory network system of claim 4, wherein the query block is configured to generate the one or more query vectors based at least in part on the input sample and the previous memory state.

6. The universal recurrent event memory network system of claim 4, wherein the key block is configured to generate the one or more key vectors based at least in part on the input sample and the previous memory state.

7. The universal recurrent event memory network system of claim 4, wherein the value block is configured to generate the one or more value vectors based at least in part on the input sample and the previous memory state.

8. The universal recurrent event memory network system of claim 1, wherein the one or more key vectors comprise information associated with future addressing.

9. The universal recurrent event memory network system of claim 1, wherein the one or more value vectors comprise information associated with content.

10. The universal recurrent event memory network system of claim 1, wherein the external memory is further configured to store the one or more key vectors and the one or more value vectors as one or more key-value pairs associated with one or more time instances.

11. The universal recurrent event memory network system of claim 10, wherein the external memory is further configured to select the one or more key-value pairs based on the similarity between the one or more query vectors and the one or more key vectors.

12. The universal recurrent event memory network system of claim 10, wherein the one or more key-value pairs are representative of one or more events associated with the one or more time instances.

13. The universal recurrent event memory network system of claim 12, wherein the one or more events comprise one or more words of a statement.

14. The universal recurrent event memory network system of claim 13, wherein the external memory is configured to represent the statement by relating the one or more events with a recurrent hidden state.

15. The universal recurrent event memory network system of claim 13, wherein the external memory is configured to encode the one or more words with the input sample data and a previous hidden state.

16. The universal recurrent event memory network system of claim 1, wherein (i) the one or more key vectors comprise one or more keys, (ii) the one or more value vectors comprise one or more values, and (iii) the one or more keys are nonlinearly mapped to the one or more values.

17. The universal recurrent event memory network system of claim 1, wherein the one or more classification tasks comprise a time series prediction, a logic operator task, or question answering comprising natural language processing.

18. The universal recurrent event memory network system of claim 17, wherein the external memory is configured to execute the time series prediction by comparing similarities between the one or more query vectors and the key vectors at one or more time instances associated with how information from past samples are preserved and/or discarded.

19. The universal recurrent event memory network system of claim 1, wherein the external memory is configured to execute the one or more classification tasks by:
capturing one or more input features associated with the input sample data with one or more keys associated with the one or more key vectors; and
storing one or more values associated with the one or more outputs in the one or more value vectors.

20. The universal recurrent event memory network system of claim 1, wherein the external memory is configured to operate with continuous values and operators comprising smooth functions.
